(19) United States
(12) Patent Application Publication
(10) Pub. No.: US 2013/0323460 A1
(43) Pub. Date: Dec. 5, 2013

(54) INTERIOR TRIM PANEL FOR A MOTOR VEHICLE

(71) Applicants: Johanna Hoch, Bayreuth (DE); Gerhard Forster, Erbendorf (DE)

(72) Inventors: Johanna Hoch, Bayreuth (DE); Gerhard Forster, Erbendorf (DE)

(73) Assignee: AUDI AG, Ingolstadt (DE)

(21) Appl. No.: 13/985,799

(22) PCT Filed: Feb. 25, 2012
(86) PCT No.: PCT/EP2012/000820

§ 371 Date: Aug. 15, 2013

(30) Foreign Application Priority Data
Mar. 2, 2011 (DE) 102011012789.5

(51) Int. Cl. B60R 13/02; B32B 38/00

(52) U.S. Cl. CPC B60R 13/02; B32B 38/0012; B32B 38/0004
USPC 428/117; 428/139; 156/214

(57) ABSTRACT

An interior trim panel (1) for a motor vehicle includes a carrier layer (2), a film (3) arranged on the carrier layer (2), and a metal layer (4) arranged on the film (3) and forming the outer side of the interior trim panel (1). The metal layer (4) has at least one opening (5). Part of the film (3) is located within the at least one opening (5) and forms the outer surface of the interior trim panel (1) in the area of the at least one opening (5).

The invention relates to an interior trim panel for a motor vehicle of a type defined more closely in the preamble of claim 1. Furthermore, the invention relates to a method for the production of an interior trim panel for a motor vehicle.

EP 1 577 165 B1 discloses a method for the production of an interior trim panel for a motor vehicle, with the interior trim panel having a two-dimensional, fluid-permeable metal structure which is connected with a barrier layer and a further layer. The barrier layer limits penetration of the further layer through the metal structure. This method is intended to increase the degree of freedom in designing interior trim panels of motor vehicles.

Although the described method is able to produce certain designs of interior trim panels, there is still a significant interest to enable the realization of novel effects, in particular with respect to the surface effect, on interior trim panels for motor vehicles.

It is therefore an object of the present invention to provide an interior trim panel for a motor vehicle and a method for the production thereof to further increase the design options in the passenger compartment of motor vehicles.

This object is attained in accordance with the invention by the features set forth in claim 1.

The solution according to the invention, in which the film is disposed in the region of the at least one opening of the metal layer on the outer surface thereof, enables realization of completely new optical and haptic effects in interior trim panels for motor vehicles which heretofore could not be realized with known technical means. In particular, the film provided in the at least one opening, i.e. visible on the outer side of the interior trim panel and forming part of the surface of the interior trim panel, attains a magnifying effect which results in a depth perception that could not be achieved heretofore.

A further advantage of the solution according to the invention resides in the metal combination on the outer side of the interior trim panel as a result of the different material of the film and the metal layer. Two different materials thus are provided on the surface of the interior trim panel, thereby additionally amplifying the described effect. The use of metal is especially advantageous because metal can be shaped very easily in order to realize the desired shape of the interior trim panel, and moreover has a very high stability to provide the whole interior trim panel with sufficiently high stability.

According to a very advantageous refinement of the invention, the thickness of the film may amount to 0.7-1.2 mm. A thickness of the film in this range establishes a particularly good compromise with respect to a stiffness that is adequate to prevent damage of the film on one hand, and a good malleability thereof on the other hand.

To ensure that the film is able to migrate to the surface of the metal layer through the at least one opening, the size of the at least one opening is at least 2 mm, preferably at least 3 mm, according to a very advantageous refinement.

Claim 9 sets forth a method for the production of an interior trim panel, in particular an interior trim panel according to the invention.

This method allows the production of an interior trim panel in a simple and reliable manner, whereby it is especially advantageous to form the carrier layer while at the same time the film is squeezed through the at least one opening of the metal layer so that very few operating steps are required for the production of the interior trim panel.

Further advantageous configurations and refinements of the invention are set forth in the remaining sub-claims. A basic embodiment of the invention is illustrated with reference to the invention.

It is shown in:

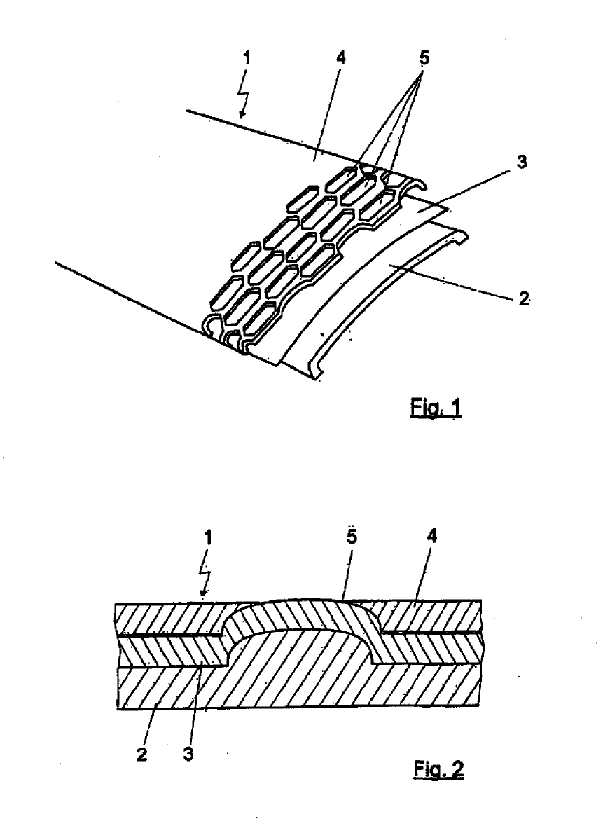

FIG. 1 a schematic view of part of an interior trim panel according to the invention; and

FIG. 2 a section through the interior trim panel of FIG. 1.

FIG. 1 shows a section of an interior trim panel 1 for a not shown motor vehicle. The interior trim panel 1 may be attached in the region of a dashboard on the inside of doors and on other know locations in the passenger compartment of the motor vehicle. The interior trim panel 1 includes a carrier layer 2, a film 3 arranged on the carrier layer 2, and a metal layer 4 which may also be designated a metal part and which is arranged on the film 3 and forms the outer side of the interior trim panel 1, i.e. the side of the motor vehicle in confronting relationship to the passenger compartment of the motor vehicle. Basically, the thus-formed interior trim panel 1 may have any shape to conform to the shape of the structure to which the interior trim panel 1 is attached.

The metal layer 4 has at least one opening 5, in the present case a plurality of openings 5, which have a honeycomb configuration in the illustrated exemplary embodiment and are arranged adjacent to one another. Of course, any shape and arrangements of the at least one opening 5 or plurality of openings 5 is conceivable across the surface of the metal layer 4.

The sectional view according to FIG. 2 shows that part of the film 3 is located within the at least one opening 5 to form the outer surface of the interior trim panel 1 in the area of the at least one opening 5.

The interior trim panel 1 is preferably made as follows: Provided in the metal part or metal layer 4 is the at least one opening 5 or openings 5, for example using a punching process. It is, however, also possible to produce the openings 5 by laser cutting or by a different manner. For example, it is also possible to cast the metal layer 4 and to produce the openings 5 during this casting process. The metal layer 4 may also involve an expanded metal part.

Subsequently, the metal layer 4 is shaped, using also processes that are known per se, and preferably painted or anodized. Of course, it is generally also possible to initially form the metal layer 4 and then provide the openings 5 therein. Also the step of painting or anodizing to realize a kind of adhesion promotion between the metal layer 4 and the film 3 may generally take place at any time. When the metal layer 4 is being anodized, an aluminum material is especially well-suited for the metal layer.

The film 3, preferably made of plastic, in particular of a transparent plastic such as polymethyl methacrylate, and preferably having a thickness between 0.7-1.2 mm, is also formed, especially thermally formed, into a shape which is suited to the shape of the metal layer 4. This thickness of the film 3 is able to realize the described magnifying effect especially well. The film 3 may be imprinted in a manner not shown to further amplify the described effect.

The metal layer 4 and the film 3 are then placed into a not shown tool while touching one another and a material for formation of the carrier layer 2 is applied upon the film 3, using preferably the so-called back-injection molding. This application of the material for formation of the carrier layer 2 is realized in such a way that the applied pressure causes the film 3 to be forced into the openings 5 so that the film 3, as described above, forms the outer surface of the interior trim panel 1 in the area of the openings 5 or is present on the outer surface of the interior trim panel 1. The tool ensures that the film 3 is prevented from projecting beyond the outer surface of the metal layer 4. Preferably, the formation of the carrier layer 2 involves the use of a plastic material which can be processed in a manner known per se in order to form the carrier layer 2. When the carrier layer 2 has a bright color, the afore-described effects are further amplified.

A size for the diameter or clear width of at least 2 mm, preferably at least 3 mm for the at least one opening 5 has proven beneficial. In the event the opening 5 does not have a symmetrical configuration, as shown in the present case, the smallest side length of the opening 5 should be at least 2 mm, preferably at least 3 mm. This ensures that the film 3 reaches through the openings 5 to the surface of the metal layer 4.

What is claimed is:

1.-10. (canceled)

11. An interior trim panel for a motor vehicle, comprising:
a carrier layer;
a film arranged on the carrier layer; and
a metal layer arranged on the film and forming the outer side of the interior trim panel, said metal layer including at least one opening,
wherein part of the film is located within the at least one opening and forms an outer surface of the interior trim panel in an area of the at least one opening.

12. The interior trim panel of claim 11, wherein the film has a thickness of 0.7-1.2 mm.

13. The interior trim panel of claim 11, wherein the at least one opening has a size of at least 2 mm.

14. The interior trim panel of claim 11, wherein the at least one opening has a size of at least 3 mm.

15. The interior trim panel of claim 11, wherein the metal layer has a plurality of said opening configured in honeycomb shape and arranged side-by-side.

16. The interior trim panel of claim 11, wherein the film is made of plastic.

17. The interior trim panel of claim 11, wherein the film is made of transparent plastic.

18. The interior trim panel of claim 11, wherein the film is made of polymethyl methacrylate.

19. The interior trim panel of claim 11, wherein the metal layer is painted or anodized.

20. The interior trim panel of claim 11, wherein the metal layer is made of an aluminum material.

21. The interior trim panel of claim 11, wherein the carrier layer is made of a plastic material.

22. A method for the production of an interior trim panel for a motor vehicle, comprising:
producing at least one opening in a metal layer,
shaping the metal layer;
shaping a film;
placing the metal layer and the film in touching relationship in a tool; and
applying on the film a material for formation of a carrier layer such that an applied pressure causes part of the film to be pressed into at least one opening so that the part of the film in the opening forms an outer surface of the interior trim panel.

23. The method of claim 22, wherein the film is thermally formed.
